(19) United States
(12) Patent Application Publication
(10) Pub. No.: US 2005/0210394 A1
(43) Pub. Date: Sep. 22, 2005

(54) Method for providing concurrent audio-video and audio instant messaging sessions

(76) Inventors: Evan S. Crandall, Basking Ridge, NJ (US); Steven L. Greenspan, Scotch Plains, NJ (US); Nancy L. Mintz, Basking Ridge, NJ (US); David M. Weimer, Aberdeen, NJ (US)

Correspondence Address: David M. Weimer, 16 Imbrook Lane, Aberdeen, NJ, 07747, US

(21) Appl. No.: 11/079,153

(22) Filed: Mar. 14, 2005

Related U.S. Application Data
(60) Provisional application No. 60/553,046, filed on Mar. 16, 2004.

(51) Int. Cl. G06F 9/00; G06F 15/16

(52) U.S. Cl. 715/752; 709/206

(57) ABSTRACT

Methods and systems for allowing users to participate in concurrent real-time audio or audio-video communication sessions over the Internet, the public telephone networks, and other networks. A user may switch among two or more conversations, and upon doing so, can play back the conversational content that was created while the user was engaged in other conversations or other tasks. After playing back part or all of the new conversational content, the user can reply with an audio or audio-video instant message that can then be played by the other conversation participants. Temporary storage of the conversation content (the instant messages) can occur on network servers, on the sender's terminal or on the recipient's terminal, depending upon preferences and the capacity of the terminal devices.

This patent application claims the benefit of the filing date of our earlier filed provisional patent application, 60/553,046 , filed on date Mar. 16, 2004.

### BACKGROUND—FIELD OF INVENTION

This invention relates to real-time multimedia communication and messaging, and in particular, to instant messaging, and audio and audio-video communication over the Internet.

### BACKGROUND

Instant Messaging has become one of the most popular forms of communication over the Internet, rivaling E-mail. Its history can be traced from several sources: the UNIX TALK application developed during the late 1970s, the popularity of CHAT services during the early 1990s, and the various experiments with MUDs (Multi-user domains), MOOs (MUD Object-Oriented), MUSHs (Multi-user shared hallucinations), during the 1980s and 1990s

Chat Services: Chat services (such as the service provided by America-On-Line) allow two or more users to converse in real time through separate connections to a chat server, and are thus similar to Instant Messaging. Prior to 2000, most of these services were predominately text-based. With greater broadband access, audio-visual variants have gained popularity. However, the standard form continued to be text-based.

Standard chat services allow text-based communication: a user types text into an entry field and submits the text. The entered text appears in a separate field along with all of the previously entered text segments. The text messages from different users are interleaved in a list A new text messages is entered into the list as soon as it received by the server and is published to all of the chat clients (the timestamp can also be displayed). In the context of the present disclosure, the important principal governing the display and use of messages is:
A message is played immediately, whether or not the intended recipient is actually present.
   This principal is henceforth referred to as the “display immediately” principle.

Although all of chat services we know of follow the “display immediately” principle, most services also allow users to scroll back and forth in the list, so that they can see a history of the conversation. Some variants of the service allow the history (the list of text messages) to be preserved from one session to the next, and some services (especially some MOOs) allow new users to see what happened before they entered the chat.

Although audio-video chat is modeled on text-based chat, the different medium places additional constraints on the way the service operates. As in text-based services, in audio-video chat when a new message is published to the chat client, the message is immediately played, i.e., the “display immediately” principle is maintained. However, audio and audio-video messages are not interleaved like text messages. Most audio-video chat services are full-duplex and allow participants to speak at the same time. Thus, audio and audio-video signals are summed rather than interleaved. Some audio-video conference services store the audio-video interactions and allow participants (and others) to replay the conference.

Many conference applications allow participants to “whisper” to one another, thus creating a person-to-person chat. Thus, users could simultaneously participate in a multi-user chat and several person-to-person whispers. In audio chats, the multi-user chat was conveyed through audio signaling, and users could “whisper” to one another using text. Experimental versions allowed users to “whisper” using audio signaling, whiling muting the multi-user chat. Instant Messaging: Instant Messaging had its origins in the UNIX Talk application, which permitted real-time exchange of text messages. Users, in this case, were required to be online on the same server at the same time. The Instant Messaging that was popularized in the mid-1990s generalized the concept of UNIX Talk to Internet communication. Today, instant messaging applications, e.g., ICQ and AOL's AIM, are comprised of the following basic components:
a) A buddy list which indicates which friends or affiliates are currently logged into the service, and
b) An instant messenger (IM) window for each IM conversation. The IM window typically contains an area for text entry and an area archiving the session history, i.e., the sequential exchange of text messages. This widow is only present when both participants are logged into the service, and have agreed to exchange instant messages. Prior to establishing an instant messaging session, a window with only a text entry field might be used to enter an invitation to begin an IM session.

Notably, separate IM windows exist for each IM session, and each IM session typically represents the exchange of messages between two users. Thus, a user can be, and often is, engaged in several concurrent IM sessions. In most IM services, a message is not displayed until the author of a messages presses a send button or presses the return key on a the keyboard. Thus, messages tend to be sentence length. Messages are displayed in an interleaved fashion, as a function of when the message was received. UNIX Talk and ICQ allow transmission on every key press. In this way, partial messages from both participants can overlap, mimicking the ability to talk while listening.

The underlying IM system typically uses either a peer-to-peer connection or store-and-forward server to route messages, or a combination of recipient) who is not logged in, many IM applications will route the message to a store-and-forward server.

The intended recipient will be notified of the message when that recipient logs into the service. If a message is sent to a logged-in recipient, the message appears on the recipient's window “almost instantly”, i.e., as quickly as network and PC resources will allow. Thus, text messages will appear in open IM windows even if the window is not the active window on a terminal screen. This has several benefits:
a) The recipient can scan multiple IM windows, and can respond selectively; and
b) The recipient can delay responding to the last received message.

In practice, a first user might send an IM to a second user, who is logged into an IM service but who is engaged in some other activity. The second user might be editing a document on the same PC that is executing the IM application, or eating lunch far away from this PC, or sleeping. Nonetheless, the IM window on the second user's PC will display the last received IM. Concurrently, another IM window on the second user's PC terminal might represent a conversation between a third user and the second user and might also display a last received message from the third user, or if none were received, then it would display the last message sent by the second user to the third user.

As in Chat, the presentation of IM text messages are governed by the “display immediately” principle. Text messages can be viewed and/or responded to quickly or after many hours, as long as the session continues. Thus, instant messaging blurs the line between synchronous and asynchronous messaging.

Recently, IM has been extended to allow exchange of graphics, real time video, and real time voice. Using the aforementioned principal, a received graphic will be displayed in near real time but because it is a static image or a continuously-repeating, short-duration moving image, like text, the visual does not need to be viewed at the time it is received. It will persist as long as the IM session continues. However, audio and audio-video IM must be viewed when received, because audio and audio-video are time-varying signals, unlike text

Thus, IM applications that permit audio and audio-visual messages have the following limitations:
a) both participants must be logged in,
b) must operate only in synchronous fashion, and
c) The time-varying signals are transmitted in real-time and presented when received: as a result, only one audio or audio-visual IM session can practically exist at a time on a single user's PC.

The “display immediately” principle is sensible, because all heretofore audio and audio-video IM applications provide synchronous, peer-to-peer communication. Even if multiple audio- and audio-video IM sessions were permitted, a user could not be engaged in multiple concurrent, ongoing conversations. Call-waiting, a telephone service, provides a good analogy. The service allows two calls to exist on the same phone at the same time, but only one call can be active. If a call participant on the inactive line were to talk, the call-waiting subscriber would never hear it. In the same way, audio or audio-video IM transmissions are immediately presented in an active IM session. If the intended recipient is not paying attention, the message is lost.

Some IM services, allow messages to be sent to users who are not logged in to the service or who are logged in but identified as “away”. In these cases, when users log in or indicate that they are “available”, all of the text messages received while they were logged out or away are immediately displayed. However, due to storage constraints most current services do not store audio-video messages when the intended recipients are way or not logged in

To sum up, current IM art uses the “display immediately” principle: When an IM session is active, messages are presented as soon as possible. When the messages are static, as in text, the recipient can read the message at any subsequent time, as long as the session is still active. When the messages are dynamic, as in audio or audio-visual, the recipient must view them when they arrive. This principal implies that only one IM session at a time can be used for audio or audio-visual communication. This is a serious limitation, and negates one major advantage of IM: multiple, on-going asynchronous conversations. The text fonnat of real-time, text-based IM, allow IM messages from multiple people to be managed concurrently by a single user (IM users are known to easily handle two to four concurrent IM conversations). In contrast, multiple real-time audio and audio-video conversations are difficult to manage concurrently.

Audio and Audio-video conversations that don't use IM infrastructure use the same “display immediately” principle, e.g., Skype Internet Telephony. This also occurs in circuit-switched telephony (e.g., public-switched telephone network). In all cases, when two or more participants are communicating in real time, their utterances are presented to the other conversational participants as quickly as possible. Indeed, delays in transmission can adversely affect the quality of the conversation.

One apparent exception to the “display immediately” principal is voice mail and multi-media mail services. However, voice mail, e-mail and similar services differ from real-time communication in that the conversational participants do not expect to be logged into the service at the same time. Instead, electronic mail services typically rely on store-and-forward servers. The asynchronous nature of voice mail and multi-media email allow mail from multiple people to be managed concurrently by a single user.

Public-switched telephone service often offer call-waiting and call-hold features, in which a subscriber can place one call on hold while speaking on a second call (and can switch back and forth between calls or join them into a single conference call). However, in such cases, the call participant who is placed on hold can not continue speaking to the subscriber until that subscriber switches back to that call; there is no conversational activity while the call is on hold. In some services, call participants who have been placed on hold (or on a telephone queue) can signal that they wish to be transferred to voice mail; but this ends the conversation.

The push-to-talk feature found on some cellular phones (such as some Nextel and Nokia cellular phones) allows users to quickly broadcast audio information to others in a group (which can vary in size from one person to many). Thus, users can quickly switch among different conversational sessions. However, push-to-talk does not provide the “play-when-requested” capability of the present invention; it does not play back the content that was missed while the user was engaged in other conversations.

Thus, unlike text-based instant messaging, all of the heretofore known real-time communication systems which use time-varying media such as audio and video suffer from a number of disadvantages:
a) They effectively allow only one real-time conversation at a time; at best, when one conversation is active, the other conversation must be halted.
b) The messages are presented to recipients according to the “display immediately” principle. Recipient(s) of a message must therefore be present when the message is received. If they are distracted, or unable to see or hear the message, there is no way to easily repeat the last received message.

The present invention circumvents these limitations by relaxing the “display immediately” principal.

### OBJECTS AND ADVANTAGES

The present invention discloses a method and apparatus that relaxes the aforementioned “display immediately” principal and allows users to engage in multiple asynchronous, multimedia conversations. Instead of a single continuous presentation of audio or audio-video, the present invention relies on collection of short clips of time-varying signals (typically the length of a sentence uttered in audio or audio-video clip) and transmits each as a separate message, similar to the manner text messages are transmitted after pressing the enter/retum key. On the recipient side, the invention replaces the traditional principal “display immediately” with a new principal “play-when-requested”. With this new combination of presentation principles the recipient sees that a new message has arrived right away; however, information packaged as an audiovisual message is not played until the recipient requests it (or the system decides the recipient is ready to receive it; for example, users might elect to have new messages played whenever they finish replying to another message).

This invention represents an advance in IM technology and allows audio and audio-visual IM participants to delay playing and responding to audio and audio-video messages. Thus, with this new technology, audio and audiovisual conversations can gracefully move between synchronous and asynchronous modes. This method can be extended to telephony to allow multiple, asynchronous telephone conversations. The method can be further generalized to allow any mime type (Multipurpose Internet Mail Extension) or combination of mime types over any communication channel.

One novel extension of this new combination of presentation methods is text-audio and text-video IM, in which a sender types a message while receiving audio, video, or both. The transmitted message can contain text or audio/video or both. This overcomes one limitation of audio-video communication: In audio and audio-video communication, the person creating the message can be overheard. In the present invention, the person who is creating a message can speak the message or type the message within the same communication session.

The present invention also allows each party in a chat to participate without having identical media capabilities (e.g., recipients can read the text of a text-video even if they can't play video, and when a user does not have a keyboard, they can speak an audio IM.

The invention also has the advantage of supporting simple forms of archiving. Rather than store a long extended video or audio recording, the collection of audiovisual messages eliminates unnecessary content, and allows for more efficient methods for archiving and retrieving messages.

### SUMMARY

The present invention permits users to engage in multiple real-time audio and audio-video communication sessions. In accordance with the invention:
a) A user may switch between two or more conversations,
b) Upon switching to a conversation, the user may request the audio or audio-video content that was created in that conversation while the user was engaged in one or more of the other conversations. In at least one variation of this invention, the user may automatically hear and/or see the missed content upon switching to a conversation.
c) Upon switching to a conversation, and typically after hearing and/or viewing the missed content, the user may respond in various ways including recording a reply message, switching to another conversation, and forwarding, saving, or deleting the missed content.

Thus, the present invention replaces the aforementioned “display immediately” principle used in all heretofore known audio and audio-video communication methods with the “play-when-requested” principle: In accordance with the present invention, audio and audio-video content are played only when the user is ready to receive them.

The following example uses an audio-visual communication example, but it should be obvious to anyone skilled in the art that the method can be used in an equivalent manner to support audio and text-video communication. Using the present invention:

An IM user (A) sends an audio-visual message to another IM user (B). Several outcomes are possible:
1. If the two users are already communicating with one another in an IM session, then the IM window of recipient (B), will immediately show a thumbnail still image (or small set of still images) of the sender (A) along with an audio message icon. If speech recognition features are enabled, key words are also displayed in the window.
2. If no IM session exists between the two users, then the recipient (B) is notified that the sender (A) wishes to begin an IM session with them, and if permitted by the recipient (B), an IM window is created and its new contents are the same as those defined above, in Outcome 1.
3. If the intended recipient (B) is not logged in to the service, the audio-video message is sent to a store-and-forward server, subject to size constraints. When the intended recipient (B) logs in, the recipient is notified and if permitted by the recipient (B), an IM window is created and its new contents are the same as those defined above, in Outcome 1.
   The recipient is able to scan multiple, two-way IM windows, each representing a conversation with a different IM participant, and each possibly containing thumbnail still images with audio icons and printed key words. When the recipient wishes to listen to a received message, the recipient selects the video still or audio icon. This action starts a playback of the audio-video message. When desired, the recipient can reply using text, text-video, audio, or audio-video methods. Notably, the viewing and reply can occur much later than the initial receipt of the message, and multiple audiovisual messages can be concurrently presented on the recipient's terminal.

### DRAWINGS

FIG. 1 provides a illustration of what a user of the present invention might see on a visual display while in engaged in two concurrent audio conversation sessions.

FIG. 2 diagrams the interaction flow experienced by three users of the present invention, in which one user is talking separately but concurrently with each of the other two users.

FIG. 3 shows a play-when-requested software process for managing concurrent streaming conversations, such as concurrent audio or audio-video IM sessions.

FIG. 4 shows a network architecture that can support the present invention.

### DETAILED DESCRIPTION

The invention discloses a novel method that allows users to engage in several concurrent streaming conversation sessions. These conversation sessions can utilize common communication services such as those offered over the Internet or the public-switched telephone network (PSTN). Examples of such Internet services include multi-media IM (e.g., Apple's AN iChat) and voice-over-IP (e.g., Skype). Examples of telephone service include stander cellular and landline voice services as well as audio-video services that operate over the PSTN, e.g., 8×8's Picturephone, DV324 Desktop Videophone, which uses the H.324 communication standard for transmitting audio and video over standard analog phone lines. All of these services are examples of concurrent streaming conversation sessions. They are transmitted as time-varying signals (unlike text), and all use the “display immediately” principle.

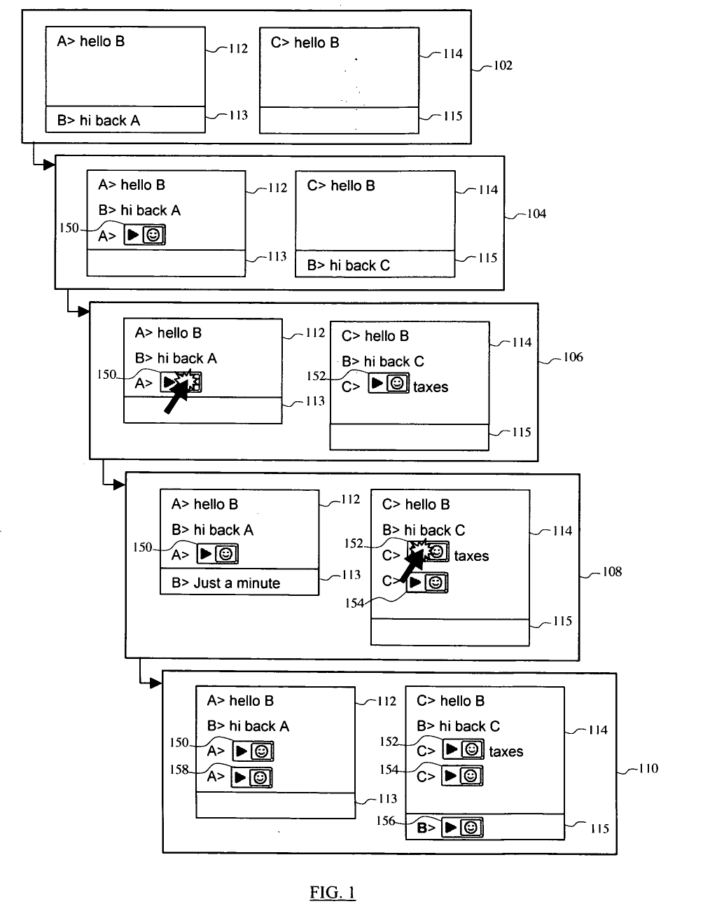

The present invention discloses a set of novel methods, which combine state of the art techniques for segmenting, exchanging, and presenting real-time multimedia streams. Support for multiple concurrent conversations that includes multimedia streams relies on the “play-when-requested” principal. A scenario using this principal is illustrated in FIG. 1.

FIG. 1-Scenario of Voice IM Service in the Preferred Embodiment

FIG. 1 illustrates two concurrent conversation sessions, in which the service operation is controlled via a visual display, one occurring between Participants A and B, and the other between Participants B and C. In this illustrative example, both conversations are managed through IM clients that have been modified in accordance with the present invention. However, the present invention does not require that all concurrent conversations use the same communication protocols or clients. One conversation session could use an IM client and another could use a VoIP client, and both could share common resource, such as input (microphones) and output (speakers). In this example, all of the time-varying messages are audio, but some or all of them could have been audio-video. Selecting an audio indicator causes an audio-player to play the message, such as RealPlayer. Selecting an audio-video message causes the message to play on an audio-video player such as Windows Media Player. Using a graphic indicator to start, pause, or continue playing an audio or audio-video play is well known in the art.

FIG. 1 illustrates the exchange of messages from the perspective of the IM client of Participant B. In Step 102, Participant B is engaged in two concurrent IM sessions. This means that Participants A, B, and C have logged into the IM service and agreed to participate in IM sessions with one another. Participant B sees a typed message from both Participant A in IM log 112 and from Participant C in IM log 114. These are separate conversations; A and C may be unaware that they are both exchanging instant messages with B. In Step 102, Participant B also chooses to respond to Participant A by typing, “hi back A”, into input window 113. A speech recognition system has detected the keyword “taxes” in the audio message, and has placed the text equivalent next to the indicator. Speech recognition and its use for labeling voice messages is well known in the art.

In Step 104, Participant B's message has been added to IM log 112, and Participant B also sees an audio-video message indicator 150 from Participant A in IM log 112. In addition, Participant B responds to Participant C by typing, “hi back C” into input window 115.

In Step 106, Participant B selects audio message indicator 150 for playback and while listening, Participant B also sees an audio message indicator 152 from Participant C.

In Step 108, while listening to the audio message from Participant A, Participant B notices that an additional message has been received from Participant C, indicated by audio message indicator 154. Participant B decides not to respond immediately to the message associated with audio message indicator 150 and instead selects audio message indicator 152 to listen to both of Participant C's audio messages. While listening to the messages associated with indicators 152 and 154, Participant B types a message to Participant A in input window 113.

In Step 110, Participant B responds to Participant C's audio message by recording a new audio message 156, while also noticing a second audio-video message indicator 158 from Participant A. In this way, Participant B can concurrently converse with both Participants A and C without ostensibly putting either on “hold”. Both Participants A and C can record new messages at the same time that Participant B is listening or responding to one of their prior messages.

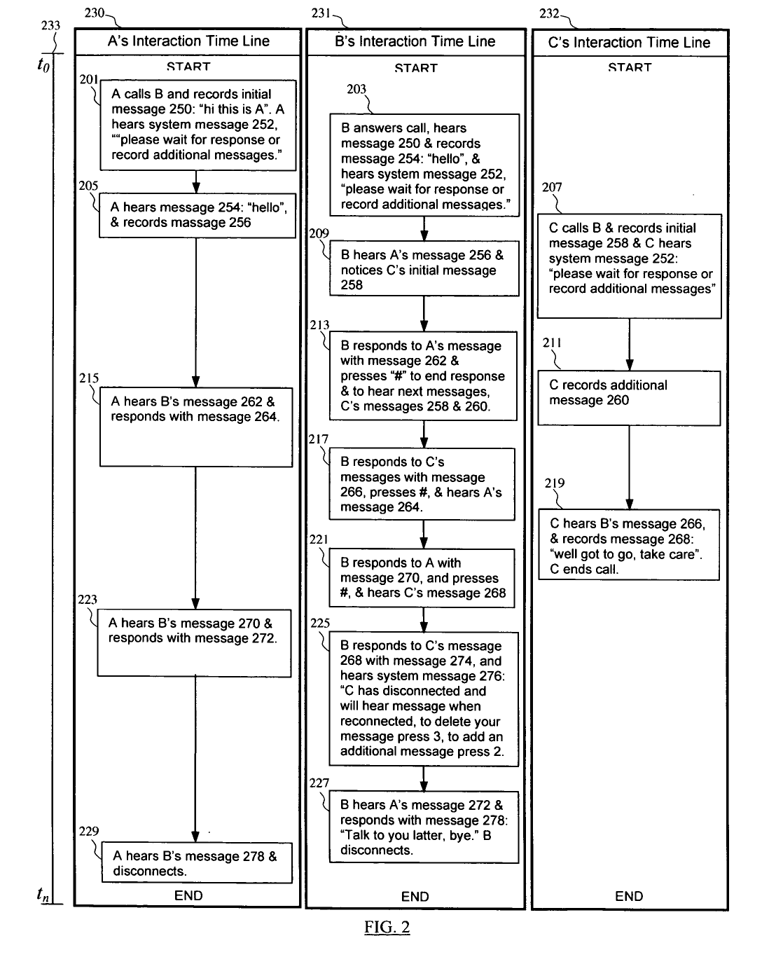

FIG. 2-Scenario of Voice IM Service in an Alternative Embodiment

FIG. 2 illustrates a similar scenario using a standard telephone pad. In this illustration, Participants A, B and C are talking over the telephone: A and B are talking, and B and C are having an independent, concurrent conversation. The three participants might be using different types of phones, e.g., cellular, wi-fi enabled, or landline but in both cases connection is established through the public-switched network. It obvious that the same illustration can be used to describe calls that are connected through the Internet or any other communication network or combination of communication networks. What distinguishes FIG. 1 from FIG. 2 is the assumed user interface. In FIG. 1 the user interface is audio-visual, and in FIG. 2 the user interface is phone-based. In FIG. 2, it is assumed that Participants B and C are subscribers to a voice instant messaging (IM) service, which operates in accordance with the disclosed invention. Participant A is not a subscriber, and has accessed the service by calling a phone number associated with Participant B's VIM service. FIG. 2 represents the user experience from the separate perspectives of Participants A, B, and C. These experiences are diagrammed in 230, 231 and 232 , respectively. The vertical axis of the FIG. 200 represents time from the start at time, t₀, to the end at tₙ.Thus many of the labeled events (numbered 201 through 219) may overlap in time. However, in this FIG., events with lower numbers begin before the onset of events with higher numbers.

The example in FIG. 2 assumes that the participants are using telephone which have no visual display or whose visual display is not addressable by the disclosed service. Therefore, the user interface is minimal allowing easy, rapid switching between conversation sessions. In the example, a message is terminated with a tone which signals that the recipient can skip to the next or reply to the current message. Following the end-of-message tone, detection of sound energy begins the recoding of a reply and silence pauses the system. This is meant to duplicate the common sequence of an utterance followed by a reply. The “#” key on the telephone pad is used for two purposes: (a) when a user records a new message, pressing the pound key signifies the end of a recording; and (b) pressing the “#” key also indicates that the user wishes to play the next message (i.e., RequestPlay instruction is sent by the client software to a local or remote server). In the preferred implementation, responding to a message marks it for deletion, and not responding to it, keeps it on the message queue (unless the subscriber explicitly deletes it.) Alternatively, the user interface could use spoken keywords, such as “Play”, “Reply” and “Next” for play the current message, begin recording a reply, and request the next message, respectively.

Other types of user interface styles can be accommodated. It is possible to map the functions to different keys. For example, “1” could be used to replay the current message, “2” could be used to start and stop a recording, and “#” could be used to play the next message. After discussing FIG. 2, a more complex user interface is described. Although simple interfaces are preferred, different applications may require substantially different user interfaces. Which system responses are automated and which require user choices is a matter of design, the subject of which is well understood in the art. Notably, if the device contains a visual display, the user interface could allow the user to choose which incoming message is played next.

In Step 201, Participant A calls Participant B's voice IM service with a message 250, “hi this is A.” Participant A hears an initial system message which may include message 252 informing Participant A that the message is being delivered and to wait for a response or to add an additional message. In step 203, Participant B answers the telephone and receives the message 250 from Participant A. After hearing the message, the end of which might be indicated by a tone, Participant B records message 254 and presses the “#” on the telephone pad to indicate the end of the reply. In Step 205, Participant A listens to Participant B's reply, and responds with Message 256.

In Step 207, while Participant A is listening and responding to Participant B with Message 256, Participant C calls Participant B and records an initial message 258. In Step 209, Participant B listens to Message 256 and while listening notices that another caller has sent an Instant Message (258). Notification might occur through a tone heard while listening to Message 256, or through a visual indicator if the phone set contains a visual display. In Step 211, concurrent with Participant B's listening to Message 258, Participant C records an additional message 260. In Step 213, Participant B responds to Participant A's Message 256 by pressing “*” and creating Message 262. At the end of recording this new message, Participant B presses “#” and hears the next message on Participant B's input queue, in this instance, Participant B hears both of the messages left by Participant C, 258 and 260. Concurrent with these activities, Participant A listens to Message 262 and records a new message 264 in Step 215. While Participant A is recording Message 264, Participant B responds to Messages 258 and 260 from Participant C with Message 266, in Step 217. Also in Step 217, after completing Message 266, Participant B listens to the next message on the input queue, Message 264. In Step 219, Participant C hears Message 266 and records a final message 268, “well got to go, take care.” Participant C disconnects from the phone service. In Step 221, Participant B responds to Participant A's Message 264 by recording a Message 270. After completing the response, signified by pressing “#”, Participant B hears Participant C's final message 268. Participant B could choose to ignore the message by moving to the next message in the queue, to save the message for a later playback and response, or to respond to the message. In this illustration, in Step 225, Participant B decides to respond with Message 274, and is informed by the System Message 276 that Participant is no long logged into the service, and Participant B can either delete the response 274 or add an additional message. Participant chooses neither and presses “#” for the next message in the queue. Participant C will hear Message 274 when Participant C logs back into the server. Concurrent with Steps 221 and 225, Participant A listens to Message 270 and responds with Message 272. In Step 227, Participant B listens to Message 272 and responds with final message 278. In Step 229, Participant A hears final message 278 from Participant B and ends the call. If Participant A had responded, the service would have delivered that message when Participant B logs back into the service.

Notably, Participant B as a subscriber could receive these messages using a phone or an network-enabled computing device, such as a handheld computer, a laptop, or a desktop computer.

The example in FIG. 2 provided a minimal set of functions (the core functions of the service). A more flexible service would allow subscribers a variety of options including:
responding to a first message with a new message directed toward the person who created the first message,
saving the message for later playback and response
forwarding the message to another person along with additional comments
pausing the message and later continuing with the message (this is useful for answering a regular phone call and then resuming the voice im service,
ignoring the message and playing the next message in the message queue, and
explicitly deleting the message
repeating the message
broadcasting a message to all participants in all active conversations with the subscriber.

An mapping of key presses (or spoken key words) to functions in this more flexible service might be as follows:

| Touch- | Spoken | |
|---|---|---|
| tone | Key word | function |
| # | “Next” “Skip” | Play the next message in the queue |
| * | “Back” | Play the previous message in the queue |
| 0 | “Send” | Send reply message |
| 1 | “Play” | Rewind and Play the current message |
| 2 | “Reply” | Start recording instant message |
| 3-2 | Delete reply | Delete Reply |
| 3-6 | Delete message | Delete Message |
| 4 | “Pause” | Toggle pause/continue current state (ether |
| | “Continue” | playing current message or recording reply) |
| 5 | “Broadcast” | Broadcast a message to all current |
| | | participants who are currently engaged |
| | | in a conversation with the participant |
| 7-[digit] | ‘Save in [tag]” | Save message in another |
| | | queue (such as “saved” |
| 8-[tag] | [tag] | Switch to another queue (such as |
| | “Switch to” | saved messages) |
| 9-[digit] | “Forward to | Forward message to another recipient |
| | [recipient]” | with (optional) comment |

This list is not meant to provide the complete user interface, but rather to be illustrative of the kinds of functions that could be provided. The methods and apparatus required to implement these functions (such as forwarding a message) and to do so using a touchtone, speech recognition, visual and multimodal interfaces are well known in the art.

Although FIG. 1 and FIG. 2 illustrate the present invention with pairs of communication sessions each involving two users. However, the present invention allows multiple users to participate in each communication session. For example, in FIG. 1, the left side conversation session could have three participants and the in Step 108, the first audio message 152 could have come from Participant C as shown, but the second audio message 154 could have come from a third participant on the conversation, Participant D. In this case, the service logic would work the same. Selecting audio message 152 would cause both messages 152 and 154 to play, because both were consecutively recorded in the conversation session and neither had been listened to by Participant C. In FIG. 2, the same approach holds for messages 258 and 260. As shown they both were created by Participant C. But the present invention allows conferencing, and message 260 could have been created by a Participant D. In Step 213, Participant C would hear both messages 258 and 260 one after the other, because both were consecutively recorded in the conversation session and neither had been listened to by Participant C.

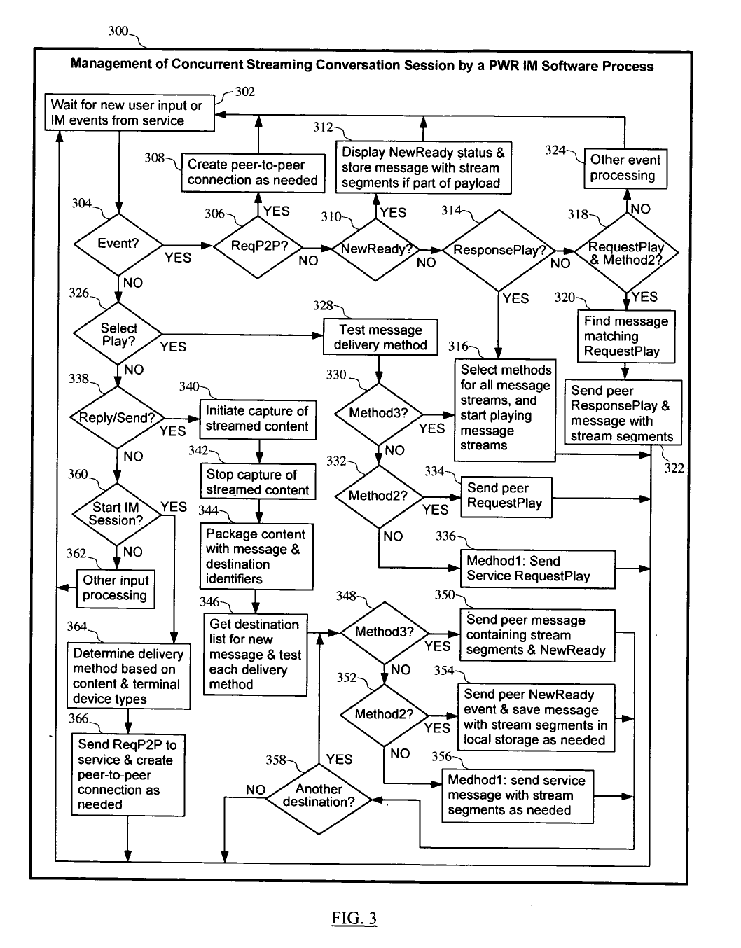

FIG. 3—Operation

Process for managing concurrent streaming conversations:

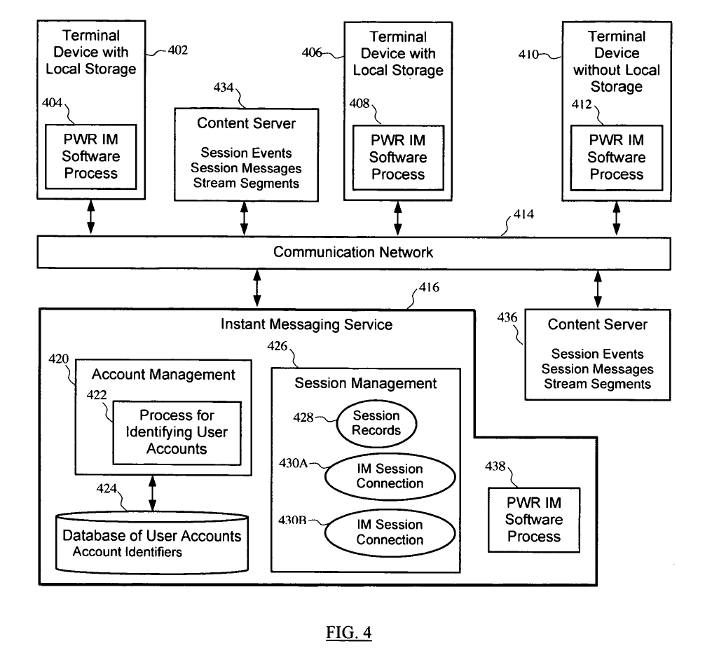

FIG. 3 is a flow chart that illustrates the key elements of managing concurrent streaming conversation methods using the play-when-requested principle. FIG. 3 is an example of a play-when-requested instant messaging software process like those illustrated in elements 404, 408, and 412, of FIG. 4. The process in FIG. 3 would be suitable for producing interactive displays of messages like those shown in FIG. 1. The methods for recording, transmitting, and receiving streamed content are well known in the art.

The login process from an instant messaging client to a server establishes a TCP/IP connection for relaying events through the service. These connections provide a means for transmitting signals between processes that are used for initiating and controlling said concurrent, streaming conversation sessions among a plurality of users who communicate with one another in groups of two or more individuals, said system allowing each user to concurrently receive and individually respond to separate streaming messages from said plurality of users. These connections also provide a means for transmitting at least one of said streaming messages. Further information regarding TCP/IP socket connections can be found in: “The Protocols (TCP/IP Illustrated, Volume 1)” by Richard Stevens, Addison-Wesley, first edition, (January 1994). When peer-to-peer connections are needed, TCP/IP connections are established directly between terminal devices. Network streaming of content can be implemented through any standard means, including RTP/RTSP protocols. For more information on the RTP protocol see the IETF document: http://www.ietf.org/rfc/rfc1889. txt. For more information on RTSP see the IETF document: http://www.ietf.org/rfc/rfc2326. txt.

Key user interface and communication events:

FIG. 3 assumes that the user is a subscriber to the instant messaging service and is already logged into the service. Once logged in, the conversation session management portion 300 of the instant messaging software process waits for new user input or communication events from the service in 302. When input or communication events have been received, software process 300 will determine the type of event in condition 304, and will invoke appropriate sub-processes and return to 302. The input events that we will describe here include the following: select play 326, send or reply 338, and start IM session 360. All other user input events are handled by sub-process 362. The communication events we will describe here include the following: request peer-to-peer connection event 306, new ready event 310, response to request play event 314, and request play event 318. All other communication events are handled by sub-process 324.

Establishing delivery and storage methods for messages with streamed content:

In FIG. 3, start IM session 360 will execute a sub-process for determining the appropriate delivery method of each stream type, based on the terminal device types involved in the communication session. For each terminal device involved in a conversation session, the process will choose a delivery method from the following: method 1, method 2, or method 3. A delivery method is chosen to establish the best means for storing at least one of said streaming messages until it is played. In method 1 stream segments are stored in a network-resident server and are later sent to any terminal device that sends a request play event. Thus, method 1 provides a means for the instant messaging service to utilize a content server for storing at least one of said streaming messages until it is played, and a means for routing said streaming messages to devices associated with the intended recipients of said streaming messages. In method 2 stream segments are stored in local storage of the terminal device sending the message, and only after receiving a request to play event are they sent through a peer-to-peer connection to the terminal device that will play the stream. Thus, method 2 provides a means for the sender's terminal device to store at least one of said streaming messages, and a means for routing said streaming messages to devices associated with the intended recipients of said streaming messages. In method 3 stream segments are sent from one terminal device, through a peer-to-peer connection, to the destination terminal device, where they are stored, waiting for the select to play user input event. Thus, method 3 provides a means for the sender's terminal process to route said streaming messages to devices associated with the intended recipients of said streaming messages. In the preferred embodiment of the invention, a conversation session can consist of two or more terminal device types with mixed capabilities, and software process 300 can choose the ideal delivery method for each terminal device, and can change that method for any situation in which it needs to. For example, when method 3 is used, the terminal device that receives too many stream segments may run out of local storage, and would notify process 300 on the other terminal devices that method 3 is no longer supported. When the delivery method needs changing in mid session, sub-processes 364 and 366 would also be performed as part of sub-process 324.

Starting an IM conversation session and setting up peer-to-peer connections:

FIG. 3 shows the identification of user input to start a new IM session in condition 360. This is followed by sub-process 364, which determines a set of delivery methods based on the terminal device streaming capabilities, and the capabilities of the other terminal devices involved in the session. This is then followed by sub-process 366, for establishing peer-to-peer connections with other terminal devices as needed when the delivery method requires them. Sub-process 366 sends ReqP2P events to the service, and the service routes these requests to the designated peer terminal software processes. When an event is determined by condition 306 to be reqP2P, sub-process 308 establishes a peer-to-peer connection with the identified terminal device as needed.

Sending a message with streamed content:

In FIG. 3, condition 338 determines if an input event is for sending/replying to a message. The input event can be a button on a keypad or a mouse or any other suitable input device. The input event for sending would be initiated in a manner that selects one or more destinations. This input event invokes the following processing steps: initiate capture of streamed content 340, stop capture of streamed content 342, package content with message and destination identifiers 344, and a sub-process for delivering the message with the appropriate delivery method for each terminal device. Steps 340, 342, and 344 constitute a means for creating at least one of said streaming messages. The source and destinations identifiers are those associated with the other terminal devices that are participating in the same conversation session. These provide a means for identifying the creator and intended recipients of said streaming messages. However, a participant can designate an archive or additional playing devices that can store or play some or all of the messages in the conversation session. In addition, software executing in the sender client or in the network can use speech recognition techniques to alter the routing of a message and to add new participants or archives.

Message delivery sub-process and the playing ofstreams:

The message delivery sub-process starts by getting the destination list for the new message for testing delivery types 346. Until condition 358 indicates there are no more destinations, a delivery method is chosen for each destination. If condition 348 chooses delivery method 3, sub-process 350 will create a message containing the stream segments and a NewReady event, and send these through a peer-to-peer connection. If condition 352 chooses delivery method 2, sub-process 354 will store the streams locally as needed, and send only the NewReady event through a peer-to-peer connection. If condition 352 chooses delivery method 1, sub-process 356 will create a message containing the stream segments and a NewReady event, and send it to the IM service, where it will store the message and its stream segments on the appropriate content server, and forward the NewReady event to the designated destinations. All NewReady events contain enough information for the devices receiving it to identify where to send RequestPlay events. When an event is determined by condition 310 to be NewReady, sub-process 312 will indicate or display the NewReady status. Sub-process 312 can also control speech recognition algorithms which could be used to label audio messages and to place the label with an audio message indicator on the recipient's user interface. If the event payload includes a message with stream segments, as a consequence of delivery method 3, sub-process 312 will store the payload in local storage until the user selects it for playing. When user input is determined by condition 326 to be SelectPlay, sub-process 328 will test the message delivery method. If condition 330 selects delivery method 3, sub-process 316 will find the message with content in its local storage, will select the appropriate playing method for each stream and will start playing those stream segments. If condition 332 selects delivery method 2, sub-process 334 will send a RequestPlay event through a peer-to-peer connection to the terminal device that is storing the message. If condition 332 selects method 1, sub-process 336 will send a RequestPlay event to the service, and the service will attempt to resolve this by returning a ResponsPlay event that includes the message with stream segments. When an event is determined by condition 318 to be RequestPlay with delivery method 2, sub-process 320 finds the message matching that RequestPlay event in local storage. Then sub-process 322 sends back a ResponsePlay event with the appropriate stream segments through the peer-to-peer connection. When an event is determined by condition 314 to be ResponsePlay, sub-process 316 will find the message with content in its local storage, will select the appropriate playing method for each stream and will start playing those stream segments.

FIG. 4—Preferred Embodiment

FIG. 4 illustrates one example of concurrent streaming conversation session instant messaging in accordance with one embodiment of the invention. In this illustration we are using an instant messaging architecture to illustrate this embodiment, which includes terminal devices 402, 406 and 410, a communication network 414, an instant messaging service 416 and a content server 436. The terminal devices 402, 406 and 410 may be, for example, a desktop computer, laptop computer, cable set top box, cellular telephone, PDA, Internet appliance, or any other mobile or non-mobile device. Depending on the type of communication desired the terminal devices 402, 406 and 410 may be in operative communication with a data communication network 414 which may be any suitable wireless or wired IP network or networks including the Internet, intranets or other suitable networks. The instant messaging service 416 performs account management 420 utilizing a database of user accounts 424 as well as providing IM session connection 430A and recording session records 428. The network content server 436 is a server in operative communication with the data communication network 414. The client content server, also referred to as local storage, resides in the terminal device 402 and/or the terminal device 406.

Network-based concurrent streaming conversation session instant messaging is performed when a user creates a session with one or more IM buddies by logging onto the instant messaging service 416 (see FIG. 3) using a terminal device without local storage 410. Using an IM interface executed on the terminal device the user can send text message to one or more buddies (see FIG. 1) who are logged into the same session using their own terminal devices without local storage 410. An audio-visual message is sent from the terminal device without local storage 410 to the network content server 436 (see FIG. 3). A new message ready status appears on each user's IM graphical display (see FIG. 1). The users can cause the audio-visual message to be streamed from the network content server by initiating a play-when-requested process 412 on their terminal device without local storage 410 (see FIG. 3).

Service 416 may be embodied in software utilizing a CPU and storage media on a single network server, such as a Power Mac G5 server running Mac OS X Server v1.3 or v 10.4 (see http://www.apple.com/powermac/ for more information on Power Mac G5 server). The server would also run server software for transmitting and storing IM messages and streams, and would be capable of streaming audio and audio-video streams to clients that have limited storage capabilities using Apple's QuickTime Streaming Server 5. Other software running on the server might include MySQL database software, FTPS, and HTTPS server software, an IM server like Jabber which uses the XMPP protocol. (see http://www.jabber.org/ for more information on Jabber and see http:/www.xmpp.org/specs/ for more information on the XMPP protocol that Jabber uses). Alternatively, Service 416 may execute across a network of servers in which account management, session management, and content management are each controlled by one or more separate hardware devices. Further information about MySQL, FTPS and HTTPS can be found at http://www.mysql.com/, http://www.ford-hutchinson.com/˜fh-1-pfh/ftps-ext.html, and http://wp.netscape.com/eng/ss13/draft302.txt.

Thick sender concurrent streaming conversation session instant messaging is performed when a user creates a session with one or more IM buddies by logging onto the instant messaging service 416 (see FIG. 3) using a terminal device with local storage 402. Using an IM interface executed on the terminal device the user can send text messages to one or more buddies (see FIG 1) who are logged into the same session using their own terminal devices without local storage 410. An audio-visual message is sent from the terminal device with local storage 402 to its local storage. A new message ready status appears on each user's IM graphical display (see FIG. 1). The users can cause the audio-visual message to be streamed from the sending device's storage by initiating a play-when-requested process 404 on their terminal 410 (see FIG. 3). A terminal device with sufficient local memory 402 and software processes 404 can operate as a thick sender or as a thin client terminal device 410.

An example of computer hardware and software capable of supported the preferred embodiment for a terminal device is an Apple Macintosh G4 laptop computer with its internal random access memory and hard disk. An iSight digital video camera with built-in microphone captures video and speech. The audio/visual stream is compressed using a suitable codec like H.264 in Apple QuickTime 7 and a controlling script assembles audio-visual message segments that are stored in local random access memory as well as on the local hard disk. The audio-visual segments are streamed on the Internet to other users on the IM session using the Apple OS X QuickTime Streaming Server and RTP/RTSP transport and control protocols. The received audio-visual content is stored on the random access memory and the hard disk on the user's Apple Macintosh G4 laptop computer terminal, and is played using the Apple QuickTime 7 media player to the laptops LCD screen and internal speakers as directed by a controlling script operated by the user. Thick receiver concurrent streaming conversation session instant messaging is performed when a user creates a session with one or more IM buddies by logging onto the instant messaging service 416 (see FIG. 3) using a terminal device without local storage 410. Using an IM interface executed on the terminal device the user can send text messages to one or more buddies (see FIG. 1) who are logged into the same session using their own terminal devices 402. An audio-visual message is sent from the terminal device without local storage 410 to the local storage on terminal device 406. A new message ready status appears on each user's IM graphical display (see FIG. 1). The users can cause the audio-visual message to be streamed from the local storage on terminal device 406 initiating a play-when-requested process 408 (see FIG. 3). A terminal device with sufficient local memory 406 and software processes 408 can operate as a thick receiver or as a thin client terminal device 410.

The user controlling a terminal device without local memory 410 (e.g., a cellular phone) may redirect the audio-visual content to another terminal device 410 (e.g., a local set top box) by directing the network content server 436 to stream directly to the other device using the IM play-when-requested process 412. Similarly a thick receiver terminal device 406 may be directed to redirect audio-visual content to another terminal device 410 using the content server 434 and IM play-when-requested process 408 and a thick sender terminal device 404 may be directed to redirect audio-visual content to a another terminal device 410 using the content server 434 and IM play-when-requested process 404.

Conclusion, Ramifications and Scope

Accordingly, the reader will see that the apparatus and operation of the invention allows users to participate in multiple, concurrent audio and audio-video conversations. Although the invention can be used advantageously in a variety of contexts, it is especially useful in business and military situations that require a high degree of real-time coordination among many individuals.

While the above description contains many specificities, these should not be construed as limitations on the scope of the invention, but rather as an exemplification of one preferred embodiment thereof. Many other variations are possible. For example, the present invention could operate using various voice signaling protocols, such as General Mobile Family Radio Service, and that the methods and communication features disclosed above could be advantageously combined with other communication features such as the buddy lists found in most IM applications and the push-to-talk feature found in cellular communication devices, such as Nokia Phones with PoC (Push-to-talk over cellular). Also the functions of the Instant Messaging Service 416 may be distributed to multiple servers across one or more of the included networks.

Accordingly, the scope of the invention should be determined not by the embodiments illustrated, but by the appended claims and their legal equivalents.

1. A method for allowing a plurality of users who communicate with one another in groups of two or more in multiple, concurrent conversation sessions that include sending and receiving streaming messages, comprising:
a. providing one or more terminal devices for creating, sending, and receiving streaming messages,
b. providing one or more storage devices which are able to store a group of streaming messages for a recipient, the group of streaming messages containing one or more streaming messages,
c. creating and sending independent and concurrent streaming messages from the one or more terminal devices to the one or more storage devices, and
d. allowing the recipient to use at least one of the terminal devices to access the one or more storage devices and to independently and selectively play back and act upon a received streaming message selected from the group of streaming messages,
whereby multiple, concurrent streaming messages from different users can be separately played back and acted upon by each recipient,
whereby each user can simultaneously participate in and alternate among separate, concurrent streaming conversations.

2. The method of claim 1, wherein the media format of said received streaming message is selected from the group comprising multimedia, audio, video, audio-video, and animated graphic content.

3. The method of claim 1, wherein the concurrent conversation sessions are concurrent Instant Messaging sessions, the Instant Messages containing streaming content selected from the group comprising multimedia, audio, audio-video, and animated graphics.

4. The method of claim 1, wherein the terminal device used by the recipient can act upon a first received streaming message from a first user with one or more actions selected from the group comprising recording a reply message for the first user, recording a reply message for the first user and all of the other recipients of the received message, playing back a second streaming message from the group of streaming messages, recording a new streaming message for one or more users selected from the plurality of users, saving the first received message for a latter response, pausing the first received message, forwarding the first received message, tagging the first received message for latter identification, replaying the first received message and deleting the first received message.

5. The method of claim 1, wherein the terminal device used by the recipient of the streaming message can forward the streaming message and associated reply message to one or more of storage devices selected from the group comprising terminal devices that are operatively connected to local storage and network devices that provide content servers.

6. The method of claim 1, wherein the recipients of the streaming message are specified in a destination list by means selected from the group comprising manual input by the user who received the streaming messages, input from software operating on the terminal devices, and input from software operating on an Instant Messaging Service platform.

7. The method of claim 1, wherein software means determine the storage devices used to store a streaming message, the storage devices selected from the group comprising local storage operatively connected to the terminal device used to create the message, local storage operatively connected to the terminal devices used to play back the message to the recipients, and storage operatively associated with one or more content servers.

8. A method for establishing and maintaining concurrent audio-visual messaging sessions among a plurality of users who communicate with one another in groups of two or more individuals, said method allowing each user to concurrently receive and individually respond to separate audio-visual messages from said plurality of users, the method comprising the steps of:
a. concurrently receiving and storing said separate audio-visual messages from at least two members of the plurality of users,
b. indicating that a plurality of said separate audio-visual messages were received from each of the at least two users, and
c. selecting one of said separate audio-visual messages for playback and response.

9. The method of claim 1, wherein the response to an audio-visual message is a reply message selected from the group comprising audio-visual, text, and graphic messages.

10. The method of claim 1, wherein the response to an audio-visual message is selected from the group comprising playing back a different audio-visual message, saving the audio-visual message for a latter response, forwarding the audio-visual message to another user, and deleting the audio-visual message.

11. A system for controlling concurrent, streaming conversation sessions among a plurality of users who communicate with one another in groups of two or more users, each streaming conversation session consisting of one or more streaming messages, and each streaming message have a creator and one or more intended recipients selected from the plurality of users, said system allowing each user to concurrently receive and individually respond to a plurality of streaming messages from said plurality of users, comprising:
a. a plurality of storage devices for storing, receiving and transmitting one or more streaming messages from said plurality of messages,
b. a group of memory addresses that identify the streaming messages that can be received by a user,
c. a plurality of terminal devices, each terminal device capable of:
(1) recording one or more streaming messages,
(2) receiving messages from one or more storage devices,
(3) sending messages to one or more storage devices,
(4) playing back one or more streaming messages,
(5) allowing a human operator to control the recording and sending of one or more streaming messages to one or more intended recipients,
(6) selecting an address in the group of memory addresses and requesting the associated streaming message for play back, and
(7) allowing a human operator to create a new streaming message as a reply to a received streaming message,
d. a communication network for routing said plurality of streaming messages
e. a means for identifying terminal devices associated with the intended recipients of each of the streaming messages,
f. a means for determining the delivery method for each streaming message, and
g. a networking means for delivering each streaming message to the terminal devices associated with the intended recipients,
whereby a user can consecutively listen to and reply to streaming messages from different users,
whereby each user can simultaneously participate-in and alternate among separate, concurrent conversations.

12. The method of claim 1, wherein the intended recipient who receives a streaming message can respond to the playback of said streaming message with one or more responses selected from the group comprising creating a reply message for the user who sent the streaming message, creating a new message for one or more users selected from the plurality of users, and playing back a different message from a different user from the plurality of users.

13. The method of claim 1, wherein the activities of each of the users do not interfere with the activities of the other users in said plurality of users, said activities selected from the group comprising receiving streaming messages, playing back streaming messages and creating streaming messages.

14. The method of claim 1, wherein the delivery method used to send a streaming message is selected by software means from the group comprising a peer-to-peer transmission in which the streaming message resides on the terminal device used to create the message, a peer-to-peer transmission in which the streaming message is streamed to the terminal devices associated with each of the intended recipients, and a mediated transmission in which a network content server stores the streaming message until requested by each of the intended recipients.

15. The method of claim 1, wherein said storage devices are selected from the group comprising terminal with local storage and content servers.

16. The method of claim 1, wherein the recipients of the streaming message are specified in a destination list by means selected from the group comprising manual input by the user who received the streaming messages, input from software operating on the terminal devices, and input from software operating on an Instant Messaging Service platform.

17. The method of claim 17, wherein the software used to specify recipients in the destination list can utilize speech recognition means to identify keywords, thereby causing the streaming message to be sent to one or more users who are interested in messages containing the keyword.

18. The method of claim 1, wherein software means determine the storage devices used to store a streaming message, the storage devices selected from the group comprising local storage operatively connected to the terminal device used to create the message, local storage operatively connected to the terminal devices used to play back the message to the recipients, and storage operatively associated with one or more content servers.

19. The method of claim 1, wherein each recipient can designate through software means one or more devices for concurrently receiving each said message, said devices selected from the group comprising network content servers and terminal devices operated by other users among the plurality of users.
